(19) United States
(12) Patent Application Publication
(10) Pub. No.: US 2026/0277254 A1
(43) Pub. Date: Sep. 17, 2026

(54) ORDER RECEPTION SYSTEM, DEVICE, AND ORDER RECEPTION METHOD

(71) Applicant: GLORY LTD., Himeji-shi (JP)

(72) Inventors: Kisho YANASE, Himeji-shi (JP); Toru FUJINO, Himeji-shi (JP); Kazunori YOSHIIKE, Himeji-shi (JP)

(73) Assignee: GLORY LTD., Himeji-shi (JP)

(21) Appl. No.: 19/557,229

(22) Filed: Mar. 5, 2026

(30) Foreign Application Priority Data
Mar. 12, 2025 (JP) 2025-039182

(51) Int. Cl. G05D 3/10; G06T 7/70

(52) U.S. Cl. CPC G05D 3/10; G06T 7/70

(57) ABSTRACT

An order reception system includes: a display device including a display configured to display information on items, and an orientation changing mechanism configured to change an orientation of the display; and an order reception device configured to receive an order for an item displayed on the display. The orientation of the display is changed based on a position of a customer who orders the item through the order reception device.

### CROSS-REFERENCE RELATED TO APPLICATION

The present application claims priority to Japanese patent application JP 2025-039182 filed Mar. 12, 2025, the entire contents of which is incorporated herein by reference.

### TECHNICAL FIELD

The present disclosure relates to an order reception system, a device and an order reception method for receiving orders from customers.

BACKGROUND ART

Conventionally, a sales system called “drive-through” has been known for selling items in the market. For example, in the drive-through system, a device installed outside a store building receives an order for items from a customer arriving at the store by a vehicle, and the ordered items are handed to the customer through a window of the vehicle. When ordering items, the customer seated in the vehicle checks a display showing a menu of items and orders items while communicating with a clerk by using a communication device provided with a microphone and speaker. Then, the customer drives to an item pickup window, makes payment for the items, and receives the purchased items.

There are various types of vehicles of customers visiting the stores, such as small vehicles, large vehicles, passenger vehicles, and commercial vehicles. There is a conventional system including a touch panel type display device with a vertically long display region in which the display positions of a menu and operation buttons can be changed in the vertical direction according to the window heights of vehicles.

In the conventional art, the height at which the item menu is displayed can be adjusted to a level, which is easy for the customer to see, within the display area of the device. However, since the position of the device is fixed, the customer needs to stop the vehicle to match the position of the device. Moreover, even when the display height is adjusted according to the height of the vehicle window, sunlight may be reflected on the screen of the display, making it difficult for the customer to see the screen. These issues cause the customer to feel stress and therefore, it is preferable to realize an order reception system that allows customers to place orders comfortably without experiencing such stress.

### SUMMARY

The present disclosure has been made in view of the problem, as well as other problems, of the conventional art, and the present disclosure addresses these issues, as discussed herein, with an order reception system, a device and an order reception method that allow customers to comfortably order items.

An order reception system according to one aspect of the present disclosure includes: a display device including a display configured to display information on items, and an orientation changing mechanism configured to change an orientation of the display; and an order reception device configured to receive an order for an item displayed on the display. The orientation of the display is changed based on a position of a customer who orders the item through the order reception device.

### BRIEF DESCRIPTION OF THE DRAWINGS

FIG. 1 is a schematic diagram illustrating an outline of an order reception system according to an embodiment of the present disclosure;

FIG. 2 is a schematic diagram showing an example of an order reception system;

FIG. 3 is a schematic diagram showing the order reception system shown in FIG. 2 as viewed from above;

FIGS. 4A and 4B are diagrams illustrating a change in angle of a display device;

FIG. 5 is a block diagram showing an example of a configuration of an order reception system including a control device;

FIG. 6 is a flowchart showing an example of a process flow executed by the control device;

FIG. 7 is a diagram showing an example of a display device, of which the position and angle can be varied; and

FIG. 8 is a diagram showing an example of a roof member, of which the position and angle can be varied.

### DESCRIPTION OF EMBODIMENTS

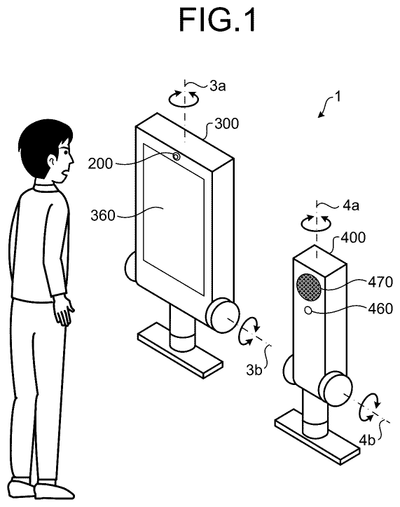

Hereinafter, an order reception system, a device and an order reception method according to the present disclosure will be described with reference to the drawings. Firstly, an outline of an order reception system 1 according to the present embodiment will be described with reference to FIG. 1. The order reception system is used by a store to receive orders for items from customers. As shown in FIG. 1, the order reception system 1 includes a display device 300 and an order reception device 400. The display device 300 includes a display 360 for displaying information on items. The order reception device 400 includes a microphone 460 and a speaker 470 through which a clerk communicates by voice with a customer who has checked the item information displayed on the display 360, and receives an order for items from the customer.

The display device 300 includes a camera 200. The camera 200 is an example of an information acquisition device that acquires information on the position of a customer. The information acquisition device acquires information on a customer who has stopped at a position near the display device 300 or the order reception device 400. The information acquisition device acquires information on the position of the customer. The display device 300 may not necessarily include the camera 200, and the camera 200 may be included in the order reception device 400. The camera 200 may be provided separately from the display device 300 and the order reception device 400.

The display device 300 can change the orientation (angle) of the display 360 by rotating the display 360 around a rotation axis 3a shown in FIG. 1. That is, the display 360 is rotatable leftward and/or rightward in a horizontal plane. The display device 300 can change the inclination (tilt angle) of the display 360 by rotating the display 360 around a rotation axis 3b shown in FIG. 1. That is, the display 360 is rotatable upward and/or downward in a vertical plane. For example, the display device 300 changes at least one of the angle in the left-right direction and the tilt angle in the front-rear direction so that the customer can easily view the display 360, according to the position of the customer detected by the camera 200.

Likewise, the order reception device 400 can change the orientation (angle) of the microphone 460 and the speaker 470 by rotating them around a rotation axis 4a shown in FIG. 1, and change the inclination (tilt angle) of the microphone 460 and the speaker 470 around a rotation axis 4b. The order reception device 400 changes at least one of the angle in the left-right direction and the tilt angle in the front-rear direction so that the customer's voice can be easily picked up by the microphone 460 and the customer can easily hear the sound reproduced by the speaker 470, according to the position of the customer detected by the camera 200.

The place where the order reception system 1 is used is not particularly limited, and the usage method may be changed depending on the store and the items sold by the store. For example, the display device 300 and the order reception device 400 may be installed inside the store building or may be installed outside the store building. The order reception device 400 may receive an order from a customer through a touch-panel type liquid-crystal display device instead of or in addition to voice communication between the customer and the clerk using the microphone and the speaker. The display device 300 may also perform the functions of the order reception device 400. That is, a single device may function as both the display device 300 and the order reception device 400. Hereinafter, the description will be continued for a drive-through sales system in which an item menu is displayed on the display device 300 installed outside a store building, and a customer arriving at the store by a vehicle orders items by voice through the order reception device 400 while remaining seated in the vehicle.

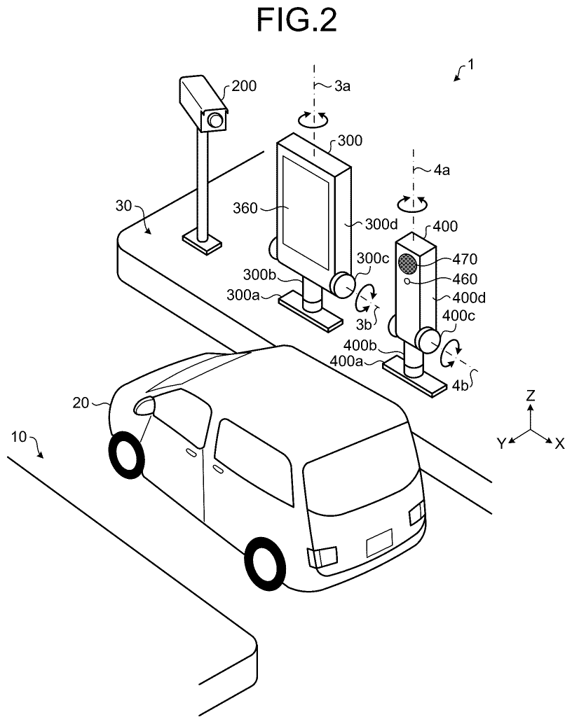

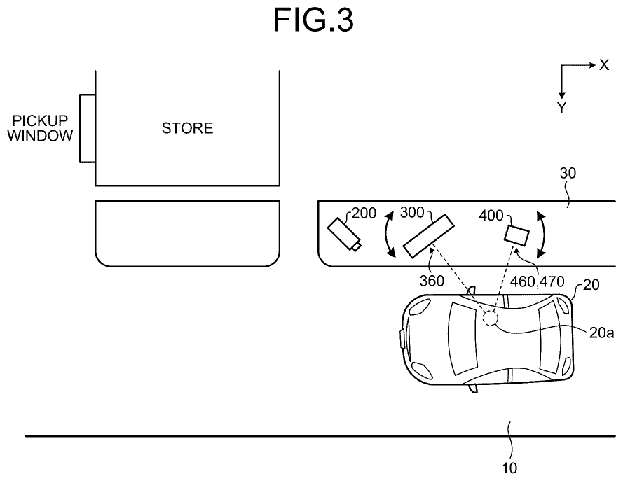

FIG. 2 is a schematic diagram showing an example of the order reception system 1. FIG. 3 is a schematic diagram showing the order reception system 1 shown in FIG. 2 as viewed from above. As shown in FIG. 2, the order reception system 1 includes: a camera 200; a display device 300 including a display 360 that displays an item menu; and an order reception device 400 including a microphone 460 and a speaker 470 through which a customer communicates by voice with a clerk for ordering items. Some of the drawings referred to in this embodiment are provided with coordinate axes to indicate the relationships of the components shown in each drawing. As for the coordinate system, when the display device 300 and the order reception device 400 are in the initial positions shown in FIG. 2, the left-right direction corresponds to the X axis, the front-rear direction corresponds to the Y axis, and the up-down direction corresponds to the Z axis. The display 360 being a liquid-crystal display device is present on the front surface of the display device 300. The microphone 460 and the speaker 470 are present on the front surface of the order reception device 400.

The display device 300 displays information for the customer ordering items, such as types of items and prices thereof. The display device 300 having such functions may sometimes be called a menu board. The order reception device 400 includes the microphone 460 and the speaker 470, and realizes communication between the clerk inside the store building and the customer outside the store building. The order reception device 400 having such functions may sometimes be called an interphone or a speaker post.

As shown in FIG. 2, the customer arriving at the store by a vehicle 20 enters a drive-through lane 10 provided on the Y-axis positive direction side of the display device 300 and the order reception device 400. The drive-through lane 10 is in front of the display device 300 and the order reception device 400 in the initial positions. The customer stops the vehicle 20 in the drive-through lane 10. The order reception system 1 detects, with the camera 200, the position of the vehicle 20 that has stopped in the drive-through lane 10.

In the order reception system 1, the angle of the display device 300 is changed according to the stopping position of the vehicle 20 so that the customer 20a in the vehicle 20 can easily view the menu screen on the display 360. Moreover, the angle of the order reception device 400 is changed according to the stopping position of the vehicle 20 so that the customer 20a and the clerk can easily communicate with each other using the microphone 460 and the speaker 470. The angle of the order reception device 400 is changed so that the content of utterance of the customer 20a can be easily picked up by the microphone 460 and the content of utterance of the clerk reproduced through the speaker 470 can be easily heard by the customer 20a. The angle of the display device 300 and/or the angle of the order reception device 400 may be changed according to the position of the customer 20a.

The information acquisition device that acquires information on the position of the customer is not limited to the camera 200, and other sensors may be used. For example, the position of the customer may be detected by using an infrared sensor, an ultrasonic sensor, a TOF (Time of Flight) sensor, etc., which are capable of detecting people, instead of or in addition to the camera 200. For another example, a plurality of pressure sensors may be installed at the road surface of the drive-through lane 10, and the position of the customer may be detected based on the position where the pressure changes. The pressure sensors may be arranged to detect positions of the vehicle tires based on pressure changes, and the position of the customer driving the vehicle may be specified based on the detection result of the vehicle. The position of the customer may be detected by using the microphone 460, based on the direction from which the voice of the customer is captured.

As shown in FIG. 2, the display device 300 rotates around the rotation axis 3a that is parallel to the Z-axis direction, to change its angle. The display device 300 rotates around the rotation axis 3b that is perpendicular to the Z axis and is parallel to the display surface of the display 360, to change its angle. By the rotation around the rotation axis 3a, the angle (orientation) of the display 360 in the left-right direction is changed. By the rotation around the rotation axis 3b, the tilt angle (inclination) of the display 360 in the front-rear direction is changed. When the display device 300 is in the initial position shown in FIG. 2, the rotation axis 3b matches the X-axis direction, and the display device 300 rotates forward or backward around the X axis. When the display device 300 rotates rightward or leftward around the rotation axis 3a from the initial position shown in FIG. 2, the display device 300 rotates forward or backward around the rotation axis 3b at the position after the change. The rotation angle is not particularly limited. In the present embodiment, the term “rotation” may be used to describe the case where the device rotates by 360° or more around the rotation axis and the case where the device changes the orientation around the rotation axis within a predetermined angle range of 360° or less.

Likewise, as shown in FIG. 2, the order reception device 400 rotates around the rotation axis 4a that is parallel to the Z-axis direction, to change its angle. The order reception device 400 rotates around the rotation axis 4b that is perpendicular to the Z axis and is parallel to the front surface of the device on which the microphone 460 and the speaker 470 are provided, to change its angle. By the rotation around the rotation axis 4a, the angle (orientation) of the microphone 460 and the speaker 470 in the left-right direction is changed. By the rotation around the rotation axis 4b, the tilt angle (inclination) of the microphone 460 and the speaker 470 in the front-rear direction is changed. When the order reception device 400 is in the initial position shown in FIG. 2, the rotation axis 4b matches the X-axis direction, and the order reception device 400 rotates forward or backward around the X axis. When the order reception device 400 rotates rightward or leftward from the initial position shown in FIG. 2, the order reception device 400 rotates forward or backward around the rotation axis 4b at the position after the change.

For example, as shown in FIG. 2, the display device 300 includes: a base 300a, a vertical shaft 300b, a horizontal shaft 300c, and a main body 300d. The base 300a is fixed to an installation surface 30 that is a surface of the installation place. The vertical shaft 300b is a left-right rotation member that is provided above the horizontal shaft 300c and rotatably supported thereby. The horizontal shaft 300c is provided above the vertical shaft 300b and fixed thereto. The main body 300d is a forward-backward rotation member that is provided above the horizontal shaft 300c and rotatably supported thereby.

The vertical shaft 300b rotates with respect to the base 300a fixed to the installation surface 30. The vertical shaft 300b having a cylindrical shape rotates around the rotation axis 3a that is an axis of the cylindrical shape. With the rotation of the vertical shaft 300b, the horizontal shaft 300c and the main body 300d including the display 360 also rotate around the rotation axis 3a. This rotation causes the display device 300 to rotate in the left-right direction.

The main body 300d rotates with respect to the horizontal shaft 300c fixed to the vertical shaft 300b. The main body 300d having a substantially rectangular parallelepiped shape rotates around the rotation axis 3b that matches the axial direction of the horizontal shaft 300c. With the rotation of the main body 300d, the display 360 provided at the front surface of the main body 300d also rotates around the rotation axis 3b. This rotation causes the display device 300 to rotate in the front-rear direction.

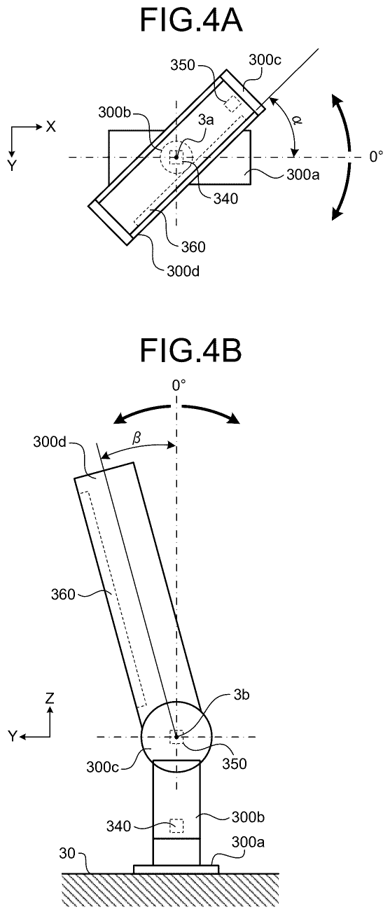

FIGS. 4A and 4B illustrate changes in angle of the display device 300. FIG. 4A shows the display device 300 as viewed from above. FIG. 4B shows the display device 300 as viewed from the right side (X-axis positive direction side).

As shown in FIG. 4A, a left-right rotation mechanism 340 including an actuator such as a motor is provided inside the display device 300. The left-right rotation mechanism 340 rotates the vertical shaft 300b around the rotation axis 3a with respect to the fixed base 300a, whereby the horizontal shaft 300c and the main body 300d including the display 360 rotate in the left-right direction.

The left-right rotation mechanism 340 can rotate the vertical shaft 300b in both clockwise and counterclockwise directions by 360° or more. The main body 300d, i.e., the display 360 provided on the front surface of the main body 300d, can rotate rightward by 360° or more and leftward by 360° or more in response to the rotation of the vertical shaft 300b. Assuming that the angle of the display 360 in the initial position where the surface (front surface) thereof is parallel to the X-axis direction is 0°, the left-right rotation mechanism 340 can rotate the main body 300d around the rotation axis 3a, and can stop the rotation at a position where an angle α of the display 360 shown in FIG. 4A is any angle in a range from 0° to 360°. However, the rotation direction and the rotation range are not particularly limited. The display 360 may rotate only in one direction. The display 360 may rotate within a predetermined angle range.

As shown in FIG. 4B, a front-rear rotation mechanism 350 including an actuator such as a motor is provided inside the display device 300. The front-rear rotation mechanism 350 rotates the main body 300d around the rotation axis 3b, whereby the main body 300d including the display 360 rotates in the front-rear direction. The rotation axis 3b may have been rotated around the axis 3a together with the horizontal shaft 300c that rotates in accordance with the rotations of the vertical shaft 300b.

The front-rear rotation mechanism 350 can rotate the main body 300d in each of the forward and backward directions within a predetermined angle range. The display 360 can rotate forward and backward according to the rotation of the main body 300d. Assuming that the angle of the display 360 in the initial position where the surface (front surface) thereof is parallel to the vertical direction is 0°, the front-rear rotation mechanism 350 can rotate the main body 300d around the rotation axis 3b, and can stop the rotation at a position where an angle β of the display 360 shown in FIG. 4B is any angle within a predetermined angle range. For example, the angle of the display 360 in the front-rear direction is changed within a range from +45° to −45°. However, the rotation direction and the rotation range are not particularly limited. The display 360 may rotate only in one direction. The display 360 may rotate within an angle range less than 45° or an angle range exceeding 45°.

The angle change of the order reception device 400 is realized in the same manner as the display device 300. A left-right rotation mechanism and a front-rear rotation mechanism, each of which includes an actuator such as a motor, are provided inside the order reception device 400. As shown in FIG. 2, the order reception device 400 includes: a base 400a fixed to the installation surface 30; a vertical shaft 400b provided rotatably in the left-right direction above the base 400a; a horizontal shaft 400c fixed to the vertical shaft 400b; and a main body 400d provided rotatably in the front-rear direction above the horizontal shaft 400c.

The left-right rotation mechanism of the order reception device 400 rotates the vertical shaft 400b with respect to the base 400a fixed to the installation surface 30, whereby a portion of the order reception device 400 above the vertical shaft 400b also rotates to the left and right. Assuming that the angle of the order reception device 400 in the initial position where the front surface of the main body 400d having the microphone 460 and the speaker 470 is parallel to the X-axis direction is 0°, the left-right rotation mechanism can rotate the main body 400d around the rotation axis 4a, and can stop the rotation at any angle in a range from 0° to 360°.

The front-rear rotation mechanism of the order reception device 400 rotates the main body 400d with respect to the horizontal shaft 400c fixed to the vertical shaft 400b, whereby the main body 400d having the microphone 460 and the speaker 470 at the front surface rotates forward and backward. Assuming that the angle of the order reception device 400 in the initial position where the front surface of the main body 400d having the microphone 460 and the speaker 470 is parallel to the vertical direction is 0°, the front-rear rotation mechanism can rotate the main body 400d around the rotation axis 4b, and can stop the rotation at any angle within a predetermined angle range. The rotation range may be set from a predetermined angle on the forward side to a predetermined angle on the backward side (e.g., from +45° to −45°).

Each of the display device 300 and the order reception device 400 may control the left-right rotation mechanism and the front-rear rotation mechanism provided therein, according to the positions of the vehicle 20 and/or the customer 20a seated in the vehicle 20 specified based on the image captured by the camera 200, to change the angle in the left-right direction and/or the angle in the front-rear direction. Each of the display device 300 and the order reception device 400 may include a control circuitry and a memory to change the angles. In this case, the control circuitry executes a program prepared in advance in the memory, specifies the position of the vehicle 20 and the customer 20a based on the image captured by the camera 200, and controls the left-right rotation mechanism and/or the front-rear rotation mechanism to change the angles according to the specified position. Alternatively, the order reception system 1 may include a control device 100 provided separately from the display device 300 and the order reception device 400. Hereinafter, a specific example of the order reception system 1 including the control device 100 will be described.

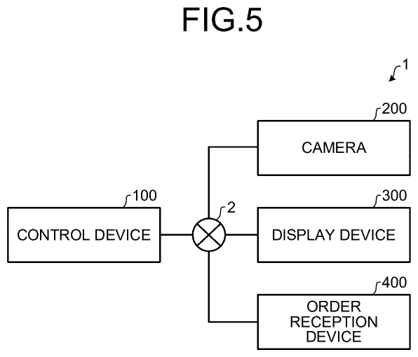

FIG. 5 is a block diagram showing a configuration example of the order reception system 1 including the control device 100. The control device 100 may be a computer device including a memory, a control circuitry, and a communication unit. A cloud server may be used as the control device 100. A plurality of computer devices may work together to realize the control device 100. The control device 100 is communicably connected to the camera 200, the display device 300, and the order reception device 400 via a network 2.

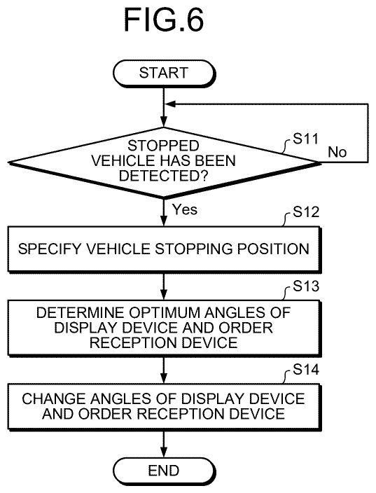

FIG. 6 is a flowchart showing an example of a process flow performed by the control device 100. The control device 100 monitors whether a vehicle 20 is present in the drive-through lane 10, based on the image captured by the camera 200 (step S11; No). When the control device 100 detects a vehicle 20 stopped in the drive-through lane 10 (step S11; Yes), the control device 100 specifies the stopping position of the vehicle 20 (step S12).

Based on the specified stopping position of the vehicle 20, the control device 100 determines optimum angles of the display device 300 and the order reception device 400 (step S13). Based on the determined optimum angles, the control device 100 changes the angles of the display device 300 and the order reception device 400 (step S14). The angle of the display device 300 is changed by the control device 100 controlling the left-right rotation mechanism 340 and the front-rear rotation mechanism 350. Likewise, the angle of the order reception device 400 is changed by the control device 100 controlling the left-right rotation mechanism and the front-rear rotation mechanism of the order reception device 400.

For example, the drive-through lane 10 is divided into a plurality of areas. A table, in which the optimum angles of the display device 300 and the order reception device 400 when the vehicle 20 is stopped in each area are associated with the area, is prepared in advance in the memory of the control device 100. The optimum angle of the display device 300 may be an optimum angle in the left-right direction and/or an optimum angle in the front-rear direction. Also, the optimum angle of the order reception device 400 may be an optimum angle in the left-right direction and/or an optimum angle in the front-rear direction.

The control device 100 specifies, from the image captured by the camera 200, which area of the drive-through lane 10 the stopping position of the vehicle 20 is located in. The control device 100 refers to the table and changes the angle of the display device 300 based on the optimum angle of the display device 300 set in the table corresponding to the specified area. Likewise, by using the table, the control device 100 changes the angle of the order reception device 400 based on the optimum angle of the order reception device 400 corresponding to the area in which the vehicle 20 is stopped. For example, at least one of the display device 300 and the order reception device 400 rotates in at least one of the left-right direction and the front-rear direction.

The method for determining the optimum angles of the display device 300 and the order reception device 400 based on the stopping position of the vehicle 20 is not limited to the method using the table. The optimum angles may be determined by using a function that receives a value corresponding to the stopping position and outputs the optimum angles.

The control device 100 may not necessarily determine, by using the table or the function, the optimum angles corresponding to each of the areas into which the drive-through lane 10 is divided. For example, a table or a function may be prepared in advance so that the optimum angles are determined based on the distance from a predetermined part of the vehicle 20, such as the front end of the body, the front tires, the front side windows, or the door mirrors, to the reference position set in advance for the drive-through lane 10. The optimum angles may be determined using the angle between a predetermined baseline and a line connecting the predetermined part of the vehicle 20 and the reference position set for the drive-through lane 10, instead of or in addition to the distance. For example, the baseline may be set to pass the reference position and to be perpendicular to the front surface of the device in the initial position.

A plurality of tables or functions for determining the optimum angles from the predetermined part of the vehicle 20 may be prepared according to the body type and/or model of the vehicle 20. For example, the control device 100 may specify the body type of the vehicle 20, such as sedan, minivan, or truck, from the image captured by the camera 200, and may set the optimum angles by using a table or a function corresponding to the specified body type. The control device 100 may specify the manufacturer and model of the vehicle 20, and may set the optimum angles by using the table or function corresponding to the specified manufacturer and the model.

The control device 100 may specify the position of the customer 20a seated in the vehicle 20 based on the image captured by the camera 200, and may determine the optimum angles of the display device 300 and the order reception device 400 based on the positional relationship between the customer 20a, the display device 300, and the order reception device 400.

For example, with reference to a straight line that passes through the approximate center of the display 360 of the display device 300 and is perpendicular to the surface of the display 360, the control device 100 may calculate and determine the angles in the left-right direction and the front-rear direction of the display device 300 so that the position of the head of the customer 20a is on the straight line or the distance from the straight line to the head is within a predetermined range.

Likewise, for example, with reference to a straight line that passes through a position predetermined based on the positions of the microphone 460 and the speaker 470 of the order reception device 400 and is perpendicular to the front surface of the device 400 having the microphone 460 and the speaker 470, the control device 100 may calculate and determine the angles in the left-right direction and the front-rear direction of the order reception device 400 so that the position of the head of the customer 20a is on the straight line or the distance from the straight line to the head is within a predetermined range. The position through which the reference straight line passes may be a position passing through the approximate center of the microphone 460. The position and direction through which the reference straight line passes may be set based on the directivity of the microphone 460.

The optimum angle of the display device 300 may be determined based on the position of a light source instead of or in addition to the positions of the vehicle 20 and the customer 20a. The light source may be natural sunlight or an artificial illumination device. After the optimum angle has been determined based on the positions of the vehicle 20 and/or the customer 20a, the control device 100 determines whether there is an influence of reflection from the light source, such as natural sunlight or artificial light from the illumination device when the display device 300 is set to the optimum angle. If there is such an influence, the optimum angle is changed to a different angle that can reduce the influence of light reflection.

For example, the control device 100 specifies the position of the sun based on the location (latitude, longitude) where the display device 300 is installed. Based on the positional relationship between the display 360 of the display device 300, the sun, and the customer 20a, the control device 100 determines whether sunlight reflected on the display 360 affects the appearance of the screen of the display 360 to the customer 20a. If there is such an influence, the control device 100 changes the optimum angle determined based on the positions of the vehicle 20 and the customer 20a to a different angle that reduces the reflection of sunlight and allows the customer 20a to easily view the screen of the display 360. For another example, when an illumination device is turned on at night, the optimum angle of the display device 300 may be changed according to the angle of light that reaches the display 360 from the illumination device.

In a specific example, a setting, in which the time, the positions of the vehicle 20 and the customer 20a, and the optimum angle of the display device 300 determined in consideration of influence of reflection of sunlight or light from the illumination device are associated with each other, may be prepared in advance. The control device 100 may determine the optimum angle of the display device 300, based on the setting, i.e., based on the time and the positions of the vehicle 20 and the customer 20a. A correction amount from the optimum angle determined based on the positions of the vehicle 20 and the customer 20a, for reducing the influence of light reflection, may be set in association with the time, and the control device 100 may correct the optimum angle determined based on the positions of the vehicle 20 and the customer 20a, according to the time. When these settings are used, the angle of the display device 300 may be changed according to the time, even if the positions of the vehicle 20 and the customer 20a are the same.

In the order reception system 1, the angle of the display device 300 that displays the menu screen can be changed according to the position of the vehicle 20 stopped in the drive-through lane 10 and/or the position of the customer 20a seated in the vehicle 20. Even for the same vehicle 20, if the stopping position differs, the angle of the display device 300 is automatically changed according to the stopping position so that the customer 20a can easily view the menu screen. Furthermore, in order to avoid the situation that the customer 20a cannot easily view the screen due to reflection of light from the light source such as the sun or the illumination device, the angle of the display device 300 is automatically changed based on the positional relationship between the customer 20a, the screen of the display 360, and the light source. This makes it possible to avoid the situation that the menu screen is difficult to see from the stopping position of the vehicle 20 and the situation that the menu screen is difficult to see due to light reflection, thereby allowing the customer 20a to comfortably order items.

In the order reception system 1, as for the order reception device 400 including the microphone 460 and the speaker 470 that the customer 20a seated in the vehicle 20 uses for conversation with the clerk when ordering items, the angle thereof is also changed so that the voice of the customer 20a easily reaches the clerk and the voice of the clerk easily reaches the customer 20a. This avoids the situation that the clerk or the customer 20a has difficulty in hearing the other's voice and needs to ask for repetition, thereby allowing the customer 20a to comfortably order items.

The angles of the display device 300 and the order reception device 400 can be changed based on the positions of the customer 20a and the vehicle 20 specified from the image captured by the camera 200. The angles of the display device 300 and the order reception device 400 may be changed based on the direction from which the voice of the customer 20a reaches the microphone 460. By using the camera 200, the angle of only one of the display device 300 and the order reception device 400 may be changed, or the angles of both devices 300 and 400 may be changed. By using the microphone 460, the angle of only one of the display device 300 and the order reception device 400 may be changed, or the angles of both devices 300 and 400 may be changed. For example, the camera 200 may be installed in the display device 300 to change the angle of the display device 300, while the angle of the order reception device 400 may be changed by using the microphone 460 of the order reception device 400.

The above-described changes in angles of the display device 300 and the order reception device 400 by the control device 100 may be independently performed by the display device 300 and the order reception device 400 each including the control circuitry and the memory, without the control device 100. Each of the display device 300 and the order reception device 400 may incorporate the control device 100.

The configurations shown in FIG. 2 and FIGS. 4A and 4B of the present embodiment are merely examples, and do not limit the configurations of the display device 300 and the order reception device 400. The illustration is made for ease of understanding the rotation of each device in the left-right and front-rear directions. For example, the vertical shafts 300b, 400b and the horizontal shafts 300c, 400c may be provided inside the main bodies 300d, 400d. For example, the display device 300 may be configured to include the main body 300d fixed to the installation surface 30 and change only the angle of the display 360 with respect to the main body 300d. Likewise, the order reception device 400 may be configured to include the main body 400d fixed to the installation surface 30 and change the angles of the microphone 460 and the speaker 470 with respect to the main body 400d. For the display device 300 and the order reception device 400, a component capable of rotating in the front-rear direction with respect to the installation surface 30 may be provided, and above this component, another component capable of rotating in the left-right direction may be provided. By using a mechanism such as a ball joint, the main bodies 300d, 400d may be rotated in another direction in addition to the left-right direction and the front-rear direction.

In the present embodiment, the angle change can be performed in both the display device 300 and the order reception device 400, but the angle change may be performed in only one of the display device 300 and the order reception device 400. Also, as for the angle to be changed, both the angle in the left-right direction and the angle in the front-rear direction are changed in the above examples, but only the angle in one of the left-right direction and the front-rear direction may be changed. Instead of providing a physical rotation shaft and rotating the display device 300 about the rotation shaft, the orientation of the display device 300 may be changed by another mechanism. For example, the orientation of the display device 300 may be changed by at least one of a link mechanism, a cam mechanism, or any other mechanical structure. The same mechanism may also be applied to the order reception device 400.

In the present embodiment, the angles of the display device 300 and the order reception device 400 are changed so that the customer can comfortably order items, but angle change may be performed for another purpose. For example, while no order is made by the customer, the angle of the display device 300 may be changed so that the display 360 of the display device 300 faces the road or the parking area of the store for the purpose of advertising the store or items sold at the store, and an advertisement may be displayed on the display 360. Likewise, the angle of the order reception device 400 may be changed so that the speaker 470 of the order reception device 400 faces the road or the parking area, and an advertisement voice may be reproduced from the speaker 470. For example, a video advertisement may be displayed on the display 360 of the display device 300, and voice of the video advertisement may be reproduced from the speaker 470 of the order reception device 400.

The present embodiment is not limited to changing the angle of the display device 300 in order to display an advertisement, and an advertisement may be automatically displayed by changing the angle of the display device 300. For example, the display device 300 may be set so that an advertisement is automatically displayed when the angle of the display device 300 is changed to face the road or the parking area. Different advertisements may be displayed when the display 360 is oriented toward the road and when it is oriented toward the parking area. The correspondence between the angle of the display device 300 and the content to be displayed on the display device 300 may be set in advance, and the corresponding content may be displayed according to the angle after the change.

The advertisement may not necessarily be displayed over the entire screen of the display 360 of the display device 300. The screen may be divided into a plurality of areas, and different contents may be displayed on the respective areas. For example, after the angle of the display device 300 is changed, the display device 300 may divide the screen into two areas, and display an advertisement on one of the areas while displaying a content other than an advertisement on the other area. The correspondence between the angle of the display device 300, the method for dividing the screen of the display device 300, and the contents to be displayed on the divided areas may be set in advance, and the display device 300 may divide the screen and display the content corresponding to each area according to the angle after the change.

The angles of the display device 300 and/or the order reception device 400 may be changed according to the weather. For example, the angle of the display device 300 may be changed so that the display device 300 takes a forward-tilted posture that makes rain or snow less likely to fall on the front surface where the display 360 is provided. Likewise, the angle of the order reception device 400 may be changed so that the order reception device 400 takes a forward-tilted posture that makes rain or snow less likely to fall on the microphone 460 and the speaker 470. The angles of the display device 300 and the order reception device 400 may be changed according to the wind direction so that the devices 300 and 400 are not directly affected by strong wind. The display device 300 and the order reception device 400 may be tilted forward to shed rainwater accumulated on the top surface or snow piled on the top surface. In order to shed rainwater or snow, the display device 300 and the order reception device 400 may repeat forward-backward rotation a plurality of times within a predetermined angle range while keeping the forward-tilted posture. For example, the control device 100 may acquire information on the weather at the current location, which is available on the Internet, and perform a control to change the angles of the display device 300 and the order reception device 400 according to the weather. The control device 100 may receive a manual operation performed according to the weather by the clerk, and change the angles of the display device 300 and the order reception device 400 accordingly.

The display content may be changed according to the tilt angle of the display device 300. As described above, by preparing the setting in which an angle is associated with the content to be displayed when the display device 300 is tilted by the angle, the display device 300 can change the display content according to the angle after the change. For example, when the display device 300 is automatically or manually tilted forward due to rain or snow and reaches the angle of the forward-tilted posture, it is highly likely that the outside temperature is dropping. Therefore, it may be set that an advertisement related to hot items may be displayed on the display device 300 that has reached the angle of the forward-tilted posture. For another example, when the angle of the display device 300 is changed to reduce the influence of light reflection caused by the morning sun, an advertisement related to items for breakfast may be displayed according to the angle change. Likewise, when the angle of the display device 300 is changed to reduce the influence of light reflection caused by a nighttime illumination device, an advertisement for predetermined items may be displayed according to the angle change.

In the present embodiment, the display device 300 and the order reception device 400 are installed independently from each other. However, a single device may operate as the display device 300 and the order reception device 400. For example, the display device 300 may be provided with a speaker and a microphone to serve as the order reception device 400.

In the present embodiment, the customer orders items by voice using the speaker and the microphone. However, the customer may order items by operating a touch panel. In this case, the display 360 of the display device 300 may be implemented as a touch-panel type liquid-crystal display device, so that the display device 300 functions as the order reception device 400 as well.

In the present embodiment, the examples of the drive-through sales system are described, but the locations where the display device 300 and the order reception device 400 are used are not particularly limited. If the display device 300 implemented as a touch-panel type liquid-crystal display device also functions as the order reception device 400, the display device 300 can be used in various locations. For example, such a display device 300 may be used in stores providing food and/or beverages, such as restaurants and fast-food outlets. The display device 300 may be used in stores selling items, such as retail stores and shopping malls. The display device 300 may be installed and used inside stores. The display device 300 may be used at other locations, such as train stations and movie theaters.

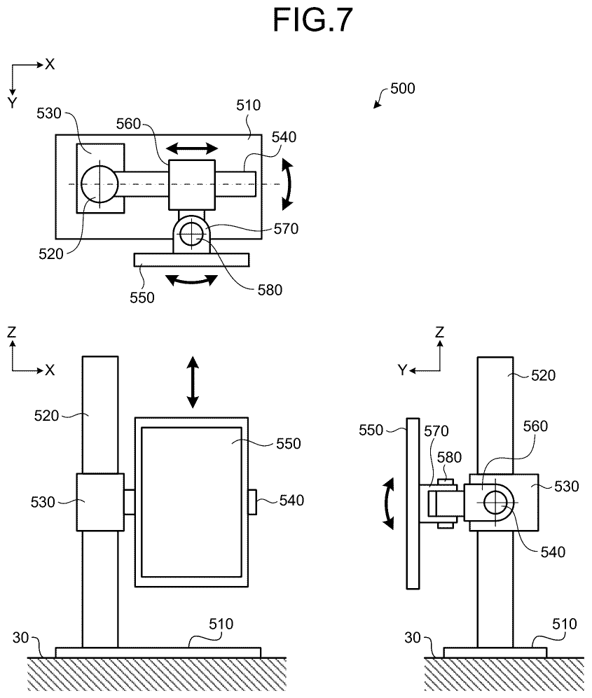

In the present embodiment, the examples in which the angles of the display device 300 and the order reception device 400 are changed are described. However, the positions of the devices may be changed instead of or in addition to the angles. A specific example will be described with reference to FIG. 7 showing a display device 500 capable of changing positions and angles. The display device 500 displays a menu of items on a screen of a display 550.

For example, as shown in FIG. 7, a vertical rail 520 having a cylindrical shape, which is fixed to and extends upward (Z-axis positive direction) from a base 510 fixed to the installation surface 30, is provided with an up-down moving member 530 movable up and down along the vertical rail 520. The up-down moving member 530 moves the position of the display 550 in the up-down direction.

A horizontal rail 540 having a cylindrical shape, which is fixed to and extends laterally (X-axis positive direction in FIG. 7) from the up-down moving member 530, is provided with a left-right moving member 560 movable left and right along the horizontal rail 540. The left-right moving member 560 moves the position of the display 550 in the left-right direction.

A support member 570 that supports the display 550 is provided in front of the left-right moving member 560 (on the Y-axis positive direction side in FIG. 7). The support member 570 rotates around a rotation shaft 580 provided in the left-right moving member 560, thereby rotating the display 550 in the left-right direction.

The left-right moving member 560 rotates around a cylindrical shaft of the horizontal rail 540 having a cylindrical shape (around a rotation shaft parallel to the X axis in FIG. 7), thereby rotating the display 550 in the front-rear direction. For example, when the display 550 is not used for taking a customer's orders, the display 550 may rotate 180 degrees around the horizontal rail 540 as a rotation shaft, so that the display 550 faces the road or the parking area on the opposite side of the drive-through lane 10 and may be used for purposes such as displaying advertisements.

The up-down moving member 530 rotates around a cylindrical shaft of the vertical rail 520 having a cylindrical shape (around a rotation shaft parallel to the Z axis in FIG. 7), thereby rotating the display 550 in the left-right direction. For example, when the display 550 is not used for taking a customer's orders, the display 550 may rotate 180 degrees around the vertical rail 520 as a rotation shaft, so that the display 550 faces the road or the parking area on the opposite side of the drive-through lane 10 and may be used for purposes such as displaying advertisements.

The parallel movement along the vertical rail 520 and the rotational movement around the vertical rail 520 of the up-down moving member 530, the parallel movement along the horizontal rail 540 and the rotational movement around the horizontal rail 540 of the left-right moving member 560, and the rotational movements of the display 550 and the support member 570 around the rotation shaft 580, may be performed by a movement mechanism including an actuator, such as a motor, provided for each movement, and a control device that controls the movement mechanism.

Depending on the type of the vehicle 20 visiting the store, the height of the customer in the vehicle 20 may vary. The display device 500 shown in FIG. 7 can change the position of the display 550 in the up-down direction so that the customer can easily check the screen of the display 550. Even when the stopping position of the vehicle 20 in the drive-through lane 10 varies forward or backward, the axial direction of the horizontal rail 540 is set to parallel to the vehicle travel direction in the drive-through lane 10, and the position of the display 550 can be changed along the horizontal rail 540 so that the customer can easily view the screen of the display 550. The angle of the display 550 can also be changed in addition to the position change.

Setting for changing the optimum position and the optimum angle of the display 550 according to the stopping position of the vehicle 20, the position of the customer 20a seated in the vehicle 20, etc., may be prepared in advance, and the control device 100 may perform control to optimize the position and/or angle of the display 550, based on the setting.

The order reception device may have a configuration similar to the display device 500 shown in FIG. 7 such that its main body part, including a microphone and a speaker, can perform parallel movement in the up-down direction, parallel movement in the left-right direction, rotation in the left-right direction, and rotation in the up-down direction.

In the example shown in FIG. 7 as well, the display device 500 may serve as an order reception device that includes a microphone and a speaker and receives a customer's order by voice. The display 550 of the display device 500 may be implemented by a touch-panel type liquid-crystal display device and receive an order from the customer through a touch operation. FIG. 7 is an example, and the display device 500 may not necessarily include some of the components shown in FIG. 7, or may include components not shown in FIG. 7.

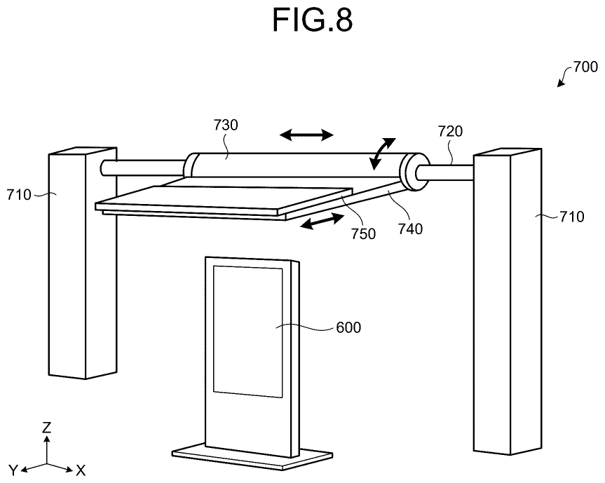

In the present embodiment, the angle of the display device 300 is changed to reduce influence of light reflection caused by sunlight or an illumination device. However, such influence of light may be reduced by changing the position or the angle of a roof member for sunshade. A specific example for sunlight will be described with FIG. 8 showing an example of a sunshade device 700 that can change the position and angle of a roof 740.

The sunshade device 700 includes: a pole 720; support posts 710; a main body 730; and a roof 740. The pole 720 is supported by the support posts 710. The main body 730 is movable laterally (in the X-axis direction) along the pole 720. The main body 730 is rotatable around the pole 720, serving as a rotation shaft. The roof 740 is fixed to the main body 730. The roof 740 extends forward (in the Y-axis positive direction) from the main body 730. The roof 740, having a thin plate shape, covers an above area of a display device 600. The parallel movement of the main body 730 along the pole 720 and the rotational movement of the main body 730 around the pole 720 as a rotation shaft are controlled according to the position of the sun, to prevent the screen of the display device 600 installed below the roof 740 from becoming difficult to view due to sunlight reflection. That is, the roof 740 moves by moving the main body 730 and the roof 740 rotates by rotating the main body 730, thereby reducing the influence of sunlight reflection on the display device 600. As for the parallel movement and the rotational movement, a movement mechanism including an actuator, such as a motor, may be provided for each movement, and the control device 100 may control the movement mechanism.

As shown in FIG. 8, the roof 740 may further include an extension member 750 that is slidable forward beyond the front end position of the roof 740. A width of the extension member 750, having a thin plate shape similar to the roof 740, in the lateral direction (X-axis direction) is approximately equal to the width of the roof 740. By sliding the extension member 750 forward, the area that can be covered by the sunshade device 700 is extended forward. By controlling the position of the extension member 750 according to the direction and/or amount of sunlight, the area of the roof 740, i.e., the area above the display device 600 covered by the roof 740, may be increased or decreased.

The slide movement of the extension member 750 may be realized by a movement mechanism including a motor or the like as in the above-described examples. Alternatively, the slide movement of the extension member 750 may be realized by its own weight of the extension member 750. For example, when the main body 730 is rotated such that the front portion of the roof 740 is tilted downward from the horizontal position, the extension member 750 in its standby position slides forward by its own weight, and stops at a protruding position where the extension member 750 protrudes further forward from the front end of the roof 740. When the main body 730 is rotated such that the front portion of the roof 740 is tilted upward from the horizontal position, the extension member 750 slides backward by its own weight from the protruding position and returns to the standby position.

Although FIG. 8 shows the display device 600 to which the display is fixed, the sunshade device 700 may be used for the rotatable display devices 300, 500 and the rotatable order reception device 400. The sunshade device 700 may be used for protecting these devices from rain and snow.

The roof 740 with the extension member 750 slidable by its own weight may be installed on the upper surface of the display device 300, 500, or may be installed on the upper surface of the order reception device 400.

For example, the roof 740 with the extension member 750 is sized and shaped to match the main body 300d of the display device 300, and is fixed to the upper surface of the display device 300. When the display device 300 is tilted forward by changing its angle, the extension member 750 slides forward due to its own weight and protrudes further forward from the front surface of the main body 300d with the display 360. According to need, the display device 300 is tilted forward, and the extension member 750 slid from the standby position above the main body 300d to the forward protruding position may be used as an eave for the display 360, thereby reducing influence of sunlight reflection and influence of rain and snow. When the extension member 750 is no longer needed, the display device 300 is tilted backward by changing its angle to return the extension member 750 from the protruding position to the retracted position.

Similar to other examples, the devices 500, 700 shown in FIG. 7 and FIG. 8 are not limited to use in a drive-through system. The devices 500, 700 may be used for a person as a target, and the angles of the devices 500, 700 may be changed based on the stopping position of a detected person. These devices 500, 700 can be used in various locations. For example, the devices 500, 700 may be used in stores providing food and beverages such as restaurants and fast-food outlets, in stores selling items such as retail stores and shopping malls, and in other locations such as train stations and movie theaters.

The configurations of the mechanisms that realize changes in angles and positions described in the present embodiment are not particularly limited. The conventionally known mechanisms may be adopted for realizing the angle changes. Each mechanism may include another actuator such as a solenoid instead of or in addition to the motor. Each mechanism may include a plurality of actuators, and further include one or more gears and/or belts.

An order reception system according to one embodiment of the present disclosure includes: a display device including a display configured to display information on items, and an orientation changing mechanism configured to change an orientation of the display; and an order reception device configured to receive an order for an item displayed on the display. The orientation of the display is changed by the rotation mechanism based on a position of a customer who orders the item through the order reception device.

In the above configuration, the orientation changing mechanism includes a rotation mechanism configured to change a rotation angle of the display by rotating the display.

In the above configuration, the display device may further include a tilt mechanism configured to change a tilt angle of the display by tilting the display. The tilt angle of the display may be changed by the tilt mechanism based on the position of the customer.

In the above configuration, the display device may further include at least one of a vertical moving mechanism configured to move the display in an up-down direction and a horizontal moving mechanism configured to move the display in a left-right direction. The position of the display may be changed by at least one of the vertical moving mechanism and the horizontal moving mechanism based on the position of the customer.

In the above configuration, the order reception device may include: an input unit configured to receive an input of information on an order for the item; and an input-unit rotation mechanism configured to change an angle of the input unit by rotating the input unit. The angle of the input unit may be changed by the input-unit rotation mechanism based on the position of the customer.

In the above configuration, the order reception device may further include an input-unit tilt mechanism configured to change a tilt angle of the input unit by tilting the input unit. The tilt angle of the input unit may be changed by the input-unit tilt mechanism based on the position of the customer.

In the above configuration, the order reception device may further include at least one of an input-unit vertical moving mechanism configured to move the input unit in the up-down direction and an input-unit horizontal moving mechanism configured to move the input unit in the left-right direction. The position of the input unit may be changed by at least one of the input-unit vertical moving mechanism and the input-unit horizontal moving mechanism based on the position of the customer.

In the above configuration, the order reception device includes a voice input device, and the position of the customer is specified based on a direction of voice of the customer received by the voice input device.

In the above configuration, the display device and the order reception device may be integrated with each other.

In the above configuration, the order reception system may further include an information acquisition device configured to acquire information on the position of the customer who orders the item through the order reception device. The orientation of at least one of the display and the input-unit may be changed based on the position of the customer specified based on the information acquired by the information acquisition device.

In the above configuration, the information acquisition device may be a camera that captures an image of a target stopped near the order reception device, and the orientation of the display and/or the input unit may be changed based on the stopping position of the target specified based on the image captured by the camera.

In the above configuration, the orientation of the display may be changed according to time.

In the above configuration, the order reception system may further include a camera configured to capture an image of a target stopped near the order reception device. The orientation of the display may be changed to an orientation that is determined based on a positional relationship between the stopping position of the target specified based on the image captured by the camera, the display, and a light source.

A device according to one embodiment of the present disclosure includes: a display configured to display information on items to be sold; and an orientation changing mechanism configured to change an orientation of the display based on a stopping position of a target stopped near the display. The device may be a display device for receiving orders of the item displayed on the display from a customer. The target that stops near the display may be the customer and/or a vehicle of the customer.

An order reception method according to one embodiment of the present disclosure includes: displaying information on items on a display; and changing an orientation of the display based on a position of a customer who orders an item through an order reception device.

The order reception system, the display device, and the order reception method according to the present disclosure improve operability of devices that customers use to order items, thereby enabling the customers to comfortably order the items.

The configuration of the order reception system described in the present embodiment is conceptually functional, and the order reception system is not physically limited to the configuration. The distributed or integrated forms of each device are not limited to the forms described above, and all or some of the forms may be distributed or integrated functionally or physically in any unit depending on various loads, use statuses, or the like.

Although the embodiment of the order reception system according to the present disclosure has been described with reference to the drawings, the configurations and operations of the order reception system and the devices constituting the system are not limited to the above embodiment, and may be carried out with various improvements, alterations, and modifications, based on the knowledge of those skilled in the art without departing from the spirit thereof.

What is claimed is:

1. An order reception system comprising:
a display device including a display configured to display information on items, and an orientation changing mechanism configured to change an orientation of the display; and
an order reception device configured to receive an order for an item displayed on the display, wherein
the orientation of the display is changed based on a position of a customer who orders the item through the order reception device.

2. The order reception system according to claim 1, wherein
the orientation changing mechanism includes a rotation mechanism configured to change a rotation angle of the display by rotating the display.

3. The order reception system according to claim 1, wherein
the display device further includes a tilt mechanism configured to change a tilt angle of the display by tilting the display, and
the tilt angle of the display is changed by the tilt mechanism based on the position of the customer.

4. The order reception system according to claim 1, wherein
the display device further includes a vertical moving mechanism configured to move the display in a vertical direction and/or a horizontal moving mechanism configured to move the display in a horizontal direction, and
the position of the display is changed by the vertical moving mechanism and/or the horizontal moving mechanism based on the position of the customer.

5. The order reception system according to claim 1, wherein
the order reception device includes:
an input unit configured to receive an input of information on the order for the item; and
a second orientation changing mechanism configured to change an orientation of the input unit, and
the orientation of the input unit is changed by the second orientation changing mechanism based on the position of the customer.

6. The order reception system according to claim 5, wherein
the order reception device further includes an input-unit tilt mechanism configured to change a tilt angle of the input unit by tilting the input unit, and
the tilt angle of the input unit is changed by the input-unit tilt mechanism based on the position of the customer.

7. The order reception system according to claim 5, wherein
the order reception device further includes an input-unit vertical moving mechanism configured to move the input unit in a vertical direction and/or an input-unit horizontal moving mechanism configured to move the input unit in a horizontal direction, and
the position of the input unit is changed by the input-unit vertical moving mechanism and/or the input-unit horizontal moving mechanism based on the position of the customer.

8. The order reception system according to claim 5, wherein the order reception device includes a voice input device, and the position of the customer is specified based on a direction of voice of the customer received by the voice input device.

9. The order reception system according to claim 1, wherein the display device and the order reception device are integrated with each other.

10. The order reception system according to claim 5, further comprising
an information acquisition device configured to acquire information on the position of the customer who orders the item through the order reception device, wherein
the orientation of the display and/or the input unit is changed based on the position of the customer specified based on the information acquired by the information acquisition device.

11. The order reception system according to claim 10, wherein
the information acquisition device is a camera that captures an image of a target stopped near the order reception device, and
the orientation of the display and/or the input unit is changed based on the stopping position of the target specified based on the image captured by the camera.

12. The order reception system according to claim 1, wherein the orientation of the display is changed according to time.

13. The order reception system according to claim 1, further comprising
a camera configured to capture an image of a target stopped near the order reception device, wherein
the orientation of the display is changed to an orientation that is determined based on a positional relationship between the stopping position of the target specified based on the image captured by the camera, the display, and a light source.

14. A device comprising:
a display configured to display information on items to be sold; and
an orientation changing mechanism configured to change an orientation of the display based on a stopping position of a target stopped near the display.

15. An order reception method comprising:
displaying information on items on a display; and
changing an orientation of the display based on a position of a customer who orders an item through an order reception device.
